(19) United States
(12) Patent Application Publication
(10) Pub. No.: US 2013/0185109 A1
(43) Pub. Date: Jul. 18, 2013

(54) Non-Emergency Transportation Dispatching, Routing, Compliance and Auditing Software and Technology

(71) Applicants: Nohad Loabneh, Greenwood, MN (US); Abedelhalim Lawabni, Blaine, MN (US); Shuhab Ahmed, Apple Valley, CA (US)

(72) Inventors: Nohad Loabneh, Greenwood, MN (US); Abedelhalim Lawabni, Blaine, MN (US); Shuhab Ahmed, Apple Valley, CA (US)

(21) Appl. No.: 13/741,371

(22) Filed: Jan. 14, 2013

Related U.S. Application Data
(60) Provisional application No. 61/585,737, filed on Jan. 12, 2012.

(51) Int. Cl. G06Q 30/00

(52) U.S. Cl. CPC G06Q 30/018
USPC 705/7.15

(57) ABSTRACT

The present disclosure relates to a computer-implemented system and method of managing non-emergency transportation to achieve a balance between cost control, high performance and high quality of service. Further goals include minimizing fraud, waste and abuse of non-emergency transportation systems.

### CROSS REFERENCE TO RELATED APPLICATIONS

This application claims the benefit of U.S. Provisional Application Ser. No. 61/585,737, titled NON-EMERGENCY TRANSPORTATING DISPATCHING, ROUTING, COMPLIANCE AND AUDITING SOFTWARE AND TECHNOLOGY, filed Jan. 12, 2012.

### BACKGROUND OF THE INVENTION

Federal law requires states to provide non-emergency medical transportation assistance to recipients of Medical Assistance (MA) and/or General Assistance Medical Care (GAMC). There are various divisions and subdivisions of said non-emergency medical transportation assistance to accommodate those with different types of needs. Many of these services are governed by regulations that require compliance by all service providers involved. Some service providers have used current unreliable systems as a means of committing fraud and thereby have created a need for a compliance and auditing system such as that disclosed herein.

The major problems with current non-emergency transportation services include a lack of consistent, reliable data, an inability to quantify compliance, high costs passed through to the state, and an overall lack of accountability, which creates an environment for fraud.

Compliance issues exist with driver training and background checks, and with vehicle regulatory compliance, safety, liability and maintenance. There is also a lack of compliance for reporting, data collection and documentation. Service issues include no-shows, “ghost” trips (trips that do not actually occur), non-qualifying trips, and mileage overcharges. Due to these and other issues with currently used systems, there is a high level of existing fraud in the non-emergency transportation field in the form of kick-backs, overcharges, preferential ride allocations, and exaggerated distances for mileage overcharges.

The disclosed non-emergency transportation compliance and auditing software and technology was created to achieve a balance between cost control, high performance and high quality of service. Further goals of the system include minimizing fraud, waste and abuse of non-emergency transportation services. To achieve these goals, the disclosed system provides for training and enforcement of policies and procedures, high quality drivers and vehicles, technology and automation of system components, compliance and tracking capabilities, and automated reporting and auditing capabilities.

The disclosed system provides electronic remote access. Users have login clearance to monitor or audit the ride database and information on a daily basis and the ability to perform random checks and obtain data regarding every aspect of a trip or ride. The system also facilitates complaint investigation and resolution and may reduce potential liability in the event of an investigation as well as provide for accountability and transparency. For all of these reasons, the system is capable of achieving substantial cost savings.

### SUMMARY OF THE INVENTION

The software and technology disclosed herein control ride requests sent in by requesting parties like HMOs or other vendors by getting the ride information from the FTP site of the vendor and by assigning the populated rides to appropriated drivers or contractors. The internet-based website or “portal” housing the software and technology is secured using an SSL certificate.

Service providers will be issued a username and password for the software. Service providers may either have their own fleet of drivers or they may employ subcontractors or independent contractors. Each service provider's main dispatcher will assign the rides to the appropriate body (contractor or driver). Drivers, using an application on their field smart phone or tablet, can designate rides as “delivered,” “no show,” “cancelled,” or “refused” (rides are refused by not assigning the ride). The rides will be updated in a live timestamp frame manner along with a client signature using the same mobile application. Once the driver updates the ride status, the update will show up on the dispatcher's module (discussed in more detail below). On the main screen of each driver's smart phone or tablet application, the driver's assigned rides are listed along with buttons for directions, mileage and GPS, and potentially many other functions.

Other compliance and auditing systems currently available are only able to run using a Windows PC. Due to the high level of fraudulent activity presented by drivers and contractors in the field, there is a need for a higher level of mobility with this type of software, which the disclosed system provides. The system as disclosed has the ability to run on any browser-enabled device, including a smart phone or tablet device.

Among other things, the disclosed system has the ability to track and store driver information and records such as background checks (criminal and driving), in-house or third party training records, certifications, drug testing, supervision, continuing education and other documentation. The system also has the ability to track and store vehicle information such as whether the vehicle is vendor-owned, whether the vehicle has a clear title, which driver the vehicle is assigned to, daily and 1,000 mile inspection results and records, routine maintenance, and other documentation. Other examples of data collection that can be tracked and stored by the system include, among other things, driver and/or vehicle numbers, passenger data and information, time, miles, fuel, client ID, trip type, locations, signatures from the client and the ride destination, and comments.

With the disclosed system and technology, rides can be reported and tracked in real-time. Each vehicle can be tracked using controlled live GPS or other alternative location verification technologies, for example, Wi-Fi. There can be customized 60 second interval tracking. There can also be trip confirmation data and trip history, which can be archived (for example, every 90 days), and GPS trip data warehouse storage. The system provides an audit function for error detection in the fields of speed, location, mileage and fuel. Cross-reference checks are incorporated into the system.

Some vendors may have FTP sites that are currently not encrypted and therefore in violation of HIPAA. The disclosed system uses a HIPAA compliant website, satisfying the HIPAA requirements by using an SSL, SQL server and a cloud-based solution. Also, in client server architecture, a part of the database with patient health information (PHI) resides on the client machines and is very hard to protect. In the disclosed system, no data resides on the client machines. Only password-secured users are allowed to log in, and once the browser window is closed or a session is ended by logging out the data is no longer visible and is not stored on client machines.

### BRIEF DESCRIPTION OF THE DRAWINGS

FIG. 1 is an example graphical user interface showing the dispatcher module with all of its functionality according to one embodiment of the present invention.

FIG. 2 is an example graphical user interface showing the dispatcher module message function according to one embodiment of the present invention.

FIG. 3 is an example graphical user interface showing the dispatcher module “add ride” function according to one embodiment of the present invention.

FIG. 4 is an example graphical user interface showing the general broadcast and credentials center of the dispatcher module according to one embodiment of the present invention.

FIG. 5 is an example graphical user interface showing the credentials center of the dispatcher module according to one embodiment of the present invention.

FIG. 6 is an example graphical user interface showing the ability of a dispatcher to view the current map location of selected drivers, according to one embodiment of the present invention.

FIG. 7 is an example graphical user interface showing the ability of a dispatcher to change the mileage of a specific ride according to one embodiment of the present invention.

FIG. 8 is an example graphical user interface showing the ability of a dispatcher to run daily reports according to one embodiment of the present invention.

FIG. 9 is an example graphical user interface showing the vendor module “add ride” function according to one embodiment of the present invention.

FIG. 10 is an example graphical user interface showing an example of the vendor edit role according to one embodiment of the present invention.

FIG. 11 is an example graphical user interface that may be viewed by a driver using a mobile application according to one embodiment of the present invention.

FIG. 12 is an example graphical user interface that may be viewed by a driver using a mobile application according to one embodiment of the present invention.

FIG. 13 is an example graphical user interface that may be viewed by a driver using a mobile application according to one embodiment of the present invention.

FIG. 14 is a flow chart illustrating the steps taken by a driver before, during and after a ride, according to one embodiment of the present invention.

FIG. 15 is an example graphical user interface illustrating the admin function to add a vendor to the system, according to one embodiment of the present invention.

FIG. 16 is an example graphical user interface illustrating the admin function to add a contractor or driver to the system, according to one embodiment of the present invention.

FIG. 17 is an example graphical user interface used by an admin to create reports and charts according to one embodiment of the present invention.

FIG. 18 is a flowchart illustrating some components of one embodiment of the presently disclosed compliance and auditing system.

FIG. 19 is a flowchart illustrating one possible agent training and implementation process for the presently disclosed compliance and auditing system.

FIG. 20 is a chart illustrating an overview of the technology used in one embodiment of the disclosed system.

FIG. 21 is a flow chart illustrating how certain portal stakeholders work together within one embodiment of the disclosed compliance and auditing system.

FIG. 22 is a schematic block diagram of an example computing system.

FIG. 23 is a flowchart illustrating compliance and fraud issues in the current non-emergency transportation system.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover applications or embodiments without departing from the spirit or scope of the claims attached hereto. Also, it is to be understood that the phraseology and terminology used herein are for the purpose of description and should not be regarded as limiting.

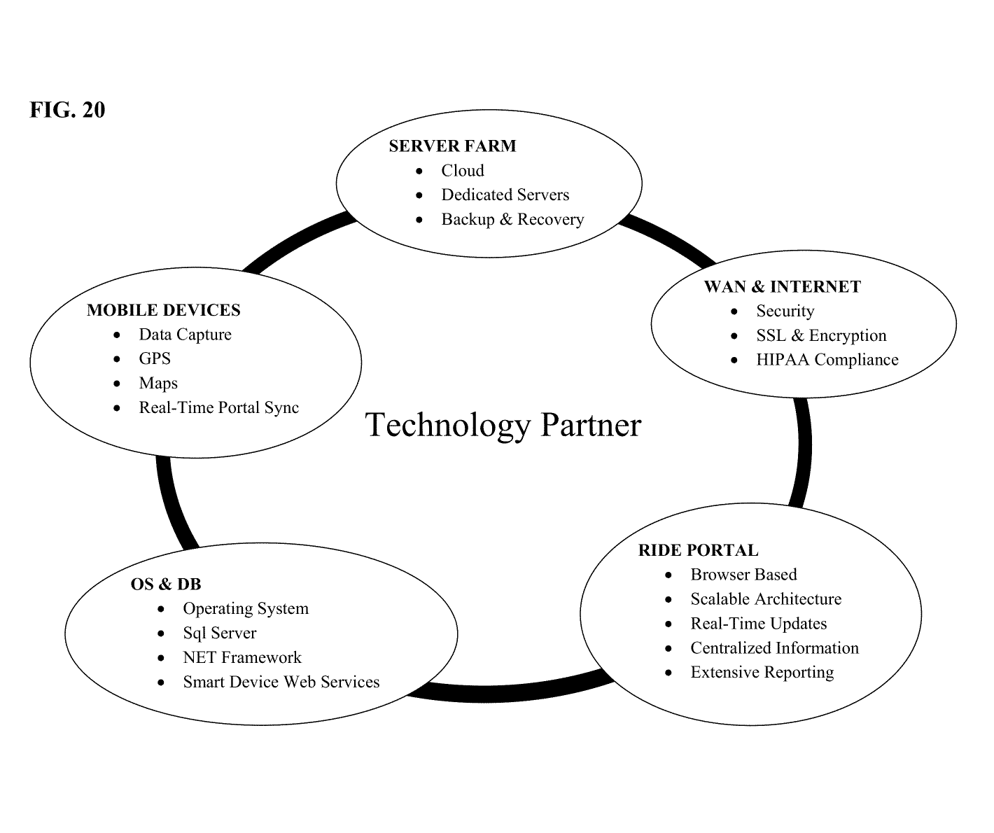

FIG. 20 is a chart illustrating an overview of the technology used in one embodiment of the disclosed system. The disclosed software uses Visual Studio 2010 as a development platform. The software itself is entirely web-based and needs only a browser to run; the software is updated only once on the required server. The internet-based website housing the software and technology is encrypted and secured using SSL and 128 bit RSA encryption for transfers over the internet.

The software platform is on an application server/database server model and implements state-of-the-art .NET framework and web technologies, and is proven to be scalable at the enterprise level. Data is stored in an enterprise-strength SQL server. The internet-based software is SSL-secured. GPS technology is supported in the web portal to store locations and timestamps. The portal supports vehicle tracking (RIDE) in real time on map based on stream data provided.

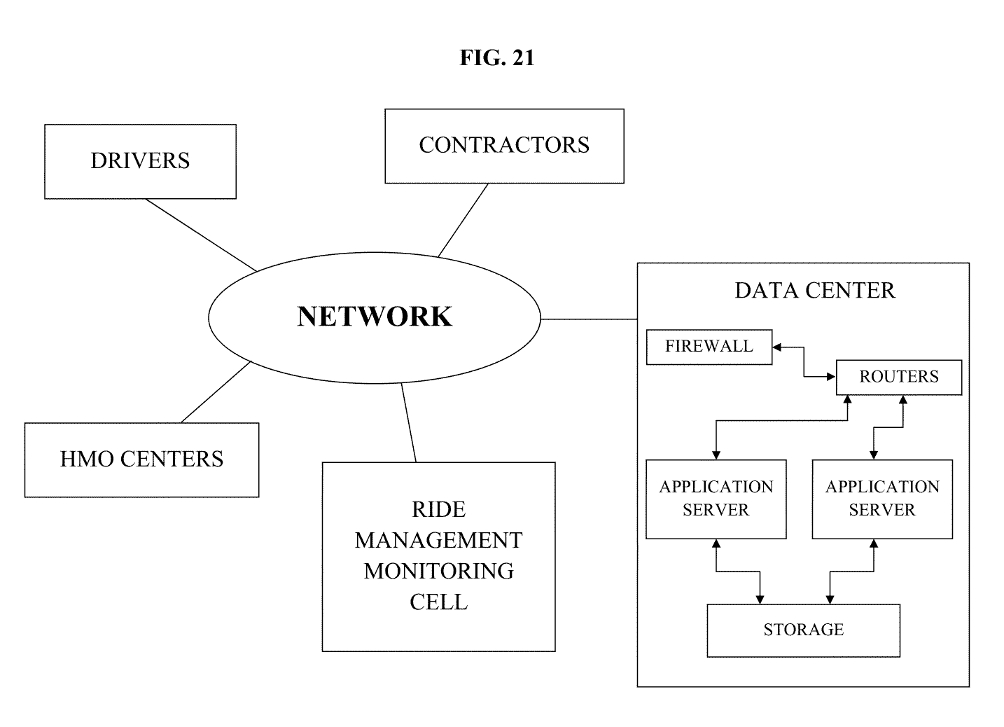

FIG. 21 is a flow chart illustrating how the portal stakeholders (including drivers, HMOs/vendors or call centers, contractors, ride management monitoring cells and data centers) work together within one embodiment of the disclosed compliance and auditing system, including a detailed drawing of the components of an example data center, according to one embodiment of the present invention.

In some embodiments, the software also has the ability to run on tablets, smart phones or other mobile devices using an operating system such as Android, Windows Mobile, iOS, or others. The tablet or smart phone application can allow the ride to appear with geocoded locations, driving instructions and live maps. Items such as passenger signatures, photos, time-stamps, and start or end geolocations can be recorded on the tablet or smart phone. The system has a “button mode” with the ability to record and send an image (such as a photo or signature) with GPS coordinates and a time-stamp to the portal when a ride starts or ends, and also has a “stream mode” to record and send GPS coordinates and time-stamps to the portal at specified intervals (for example, every one minute).

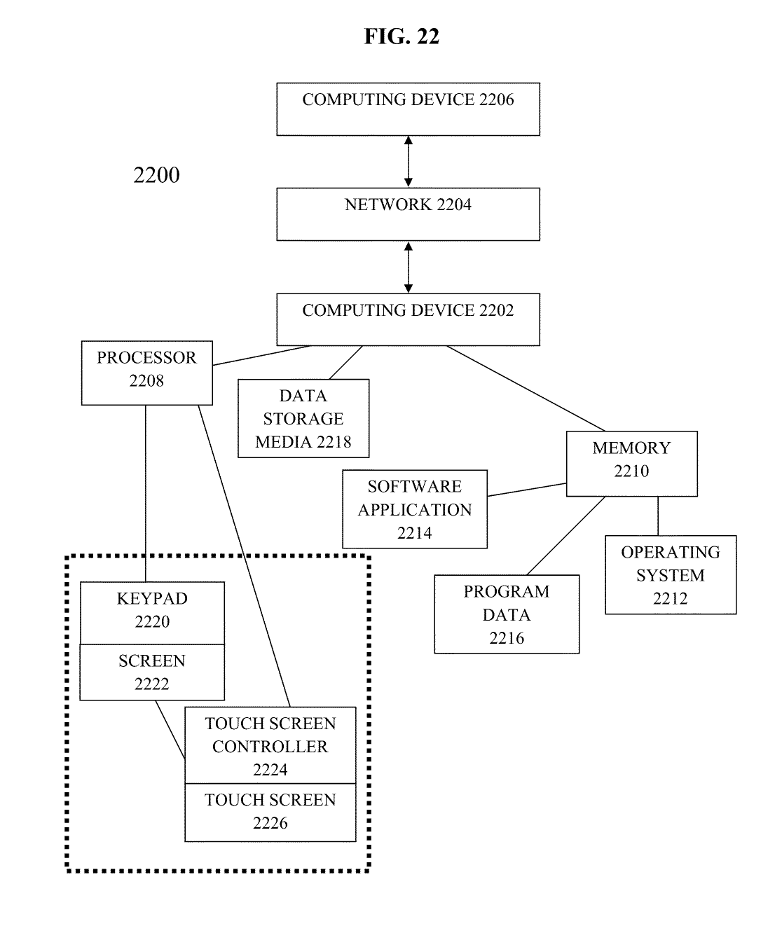

In general terms, the present disclosure relates to an online or mobile application that is executed using a computing system. FIG. 22 is a schematic block diagram of an example computing system 2200. The example computing system 2200 includes at least one computing device 2202. In some embodiments the computing system 2200 further includes a communication network 2204 (such as the internet or a cellular network) and one or more additional computing devices 2206 (such as a server).

Computing device 2202 can be, for example, a smart phone or other mobile device, a tablet computing device, a netbook, a computing device located in a user's home or in a user's office, a computing device located in a data center, or any other computing device. The computing device 2202 can be a stand-alone computing device or a networked computing device that communicates with one or more other additional computing devices 2206 across a network 2204. The additional computing device(s) can be, for example, located remote from the initial computing device 2202, but configured for data communication with the initial computing device 2202 across a network 2204. Computing device 2206 can be, for example, a server.

In some examples, the computing device 2202 or 2206 includes at least one processor or processing unit 2208 and system memory 2210. Depending on the exact configuration and type of computing device, the system memory 2210 may be volatile (such as RAM), nonvolatile (such as ROM, flash memory, etc.) or some combination of the two. System memory 2210 typically includes an operating system 2212 suitable for controlling the operation of the computing device, such as the WINDOWS® operating systems from Microsoft Corporation of Redmond, Wash. or a server, such as Windows SharePoint Server, also from Microsoft Corporation. To provide further example, if the computing device 2202 is a smart phone or other mobile device, the operating system 2212 may be iOS, Windows Phone, or any other available mobile operating system. The system memory 2210 may also include one or more software applications 2214 and may include program data 2216. The software applications 2214 may be in the form of mobile applications in examples wherein the computing device 2202 is a mobile device.

The computing device 2202 may have additional features or functionality. For example, the device may also include additional data storage devices 2218 (removable and/or non-removable) such as, for example, magnetic disks, optical disks, or tape. Computer storage media 2218 may include volatile and nonvolatile, removable and non-removable media implemented in any method or technology for storage of information, such as computer readable instructions, data structures, program modules, or other data. System memory, removable storage and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media 2218 is non-transitory media. The computing device 2206 may include data storage media such as the data storage media 2218 described above, on which data related to the disclosed system is stored.

In some examples, one or more of the computing devices 2202, 2206 can be a smart phone or other mobile device. FIG. 22 includes a schematic diagram of such device. The computing device 2202 may be a smart phone or other mobile device with input device options including, but not limited to, a keypad 2220, a screen 2222, a touch screen controller 2224, and/or a touch screen 2226. In some examples, one or more of the computing devices 2202, 2206 can be located in a vendor's, a service provider's, or any other user's place of business. In some examples, the computing device can be a personal computing device that is networked to allow the user to access the system disclosed herein at a remote location, such as in a user's home or other location. In some embodiments, the computing device is a tablet, smart phone or other mobile device. In some embodiments some components of the disclosed system are stored as data instructions for a smart phone application. A network 2204 facilitates communication between the computing device 2202 and one or more servers, such as an additional computing device 2206, that host the disclosed system. The network 2204 may be a wide variety of different types of electronic communication networks. For example, the network may be a wide-area network, such as the Internet, a local-area network, a metropolitan-area network, or another type of electronic communication network. The network may also be a cellular network in some embodiments. The network may include wired and/or wireless data links. A variety of communications protocols may be used in the network 2204 including, but not limited to, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 2206 is a Web server. In this example, the initial computing device 2202 includes a Web browser that communicates with the Web server to request and retrieve data. The data is then displayed to the user, such as using a Web browser software application. In some embodiments, the various operations, methods, and rules disclosed herein are implemented by instructions stored in memory. When the instructions are executed by the processor of one or more of computing devices 2202 and 2206, the instructions cause the processor to perform one or more of the operations or methods disclosed herein.

Further, the computing device 2202 may include image capture devices, whether a dedicated video or image capture device, smart phone or other device that is capable of capturing images and video. Further, the system may include smart phones with native or web-based applications that can capture, store and transmit time-stamped video and images to a central server. The system and method can also include location-data captured by a GPS-enabled application or device. The computing device 2202 may also have WiFi or 3G capabilities.

### Method of Operation

### Main Components

There are multiple components to the present invention.

A first component is a Windows-based software application which runs as a background process on a server. The application runs intermediately, for example every ten minutes, to check the FTP sites of vendors and download any new ride files present there. Then the application uploads the downloaded ride files to a database.

The following is a description of the application's process:

1. Checks for the vendor's files and downloads any new files.

2. Decrypts the files and moves the downloaded files to backup folder.

3. Inserts the decrypted files into database.

4. Updates the CHG files to database.

5. Checks for vendor's files and downloads the new vendor's zip files.

6. Extracts the zip files and inserts the new rides to database and updates the old files.

7. Calculates mileage for all the rides and updates mileage with driving directions.

A second component of the presently disclosed software and technology is a web application which manages rides by assigning drivers and calculating ride costs. This component is used by the different types of service providers. In one embodiment it has five modules: dispatcher, vendor, driver, independent contractor (“contractor”), and admin.

### 1. Dispatcher

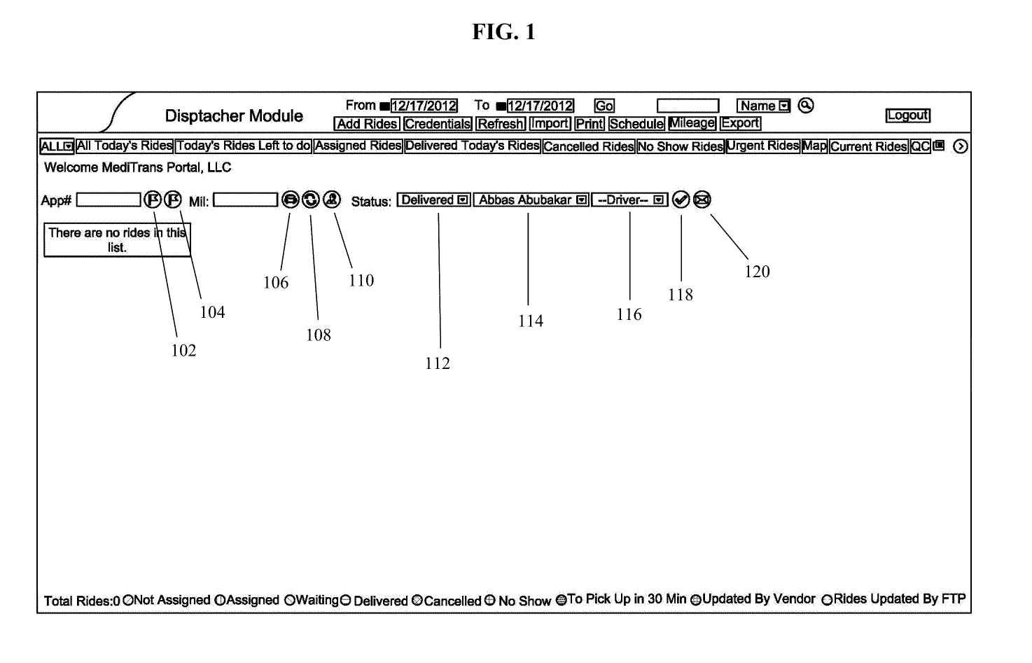

The dispatcher module is the module used by the person who manages the rides (the “dispatcher”). All the rides will be visible to a dispatcher. FIG. 1 through FIG. 8 are example graphical user interfaces that may be viewed through the dispatcher module.

Referring to FIG. 1, the dispatcher module allows a dispatcher to perform various tasks. For example, a dispatcher can assign a ride to a driver or group contracting the driver (the “contractor”) (see 114). The ride status 112 will be then changed to “assign”. If the ride has to be cancelled a dispatcher can change the status 112 to “cancelled.” If the person in need of a ride (the “rider”) does not show up for the scheduled ride, a dispatcher can change the status 112 to “no show.” Once the rider is delivered by the driver the status 112 can be changed to “delivered.” Examples of other tasks available to a dispatcher include flagging a ride as urgent (102), flagging a ride to alert the dispatcher that certain ride have specific needs (104), viewing or adding driving directions (106), calculating mileage for a ride (108), viewing the map location for a ride (110), viewing a specific driver selected (116), saving changes to a ride (118), or adding a ride (120).

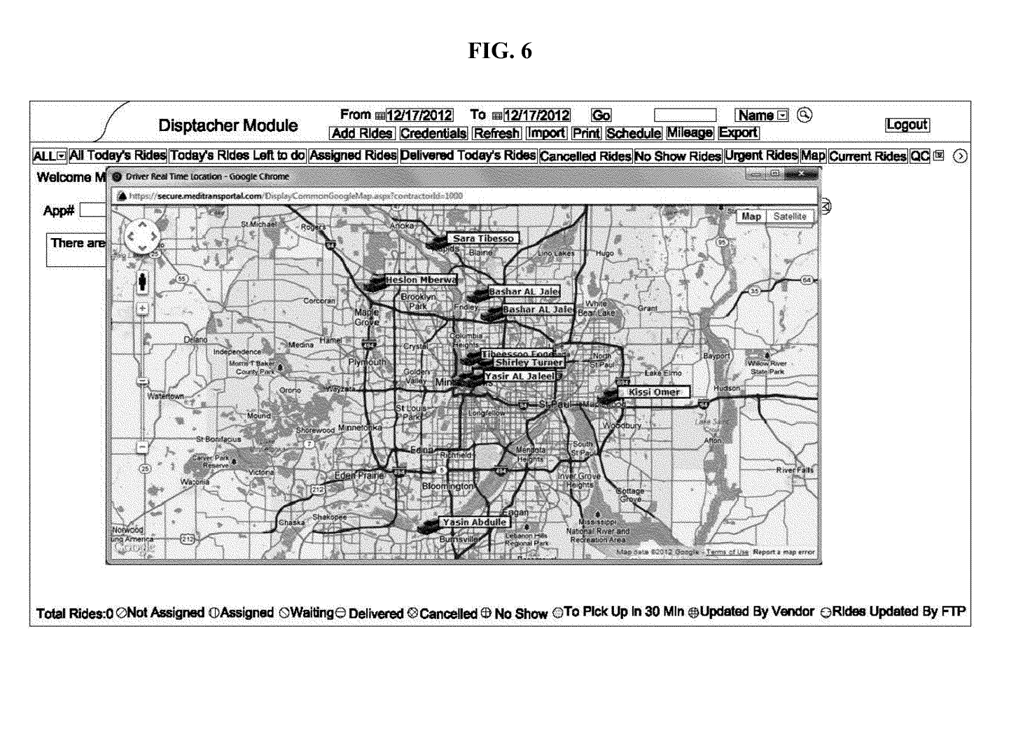

A dispatcher can view the current map locations for all selected drivers, as illustrated in FIG. 6, helping dispatchers to locate drivers. This helps to prevent fraudulent practices such as unplanned routes that add extra mileage for reimbursement.

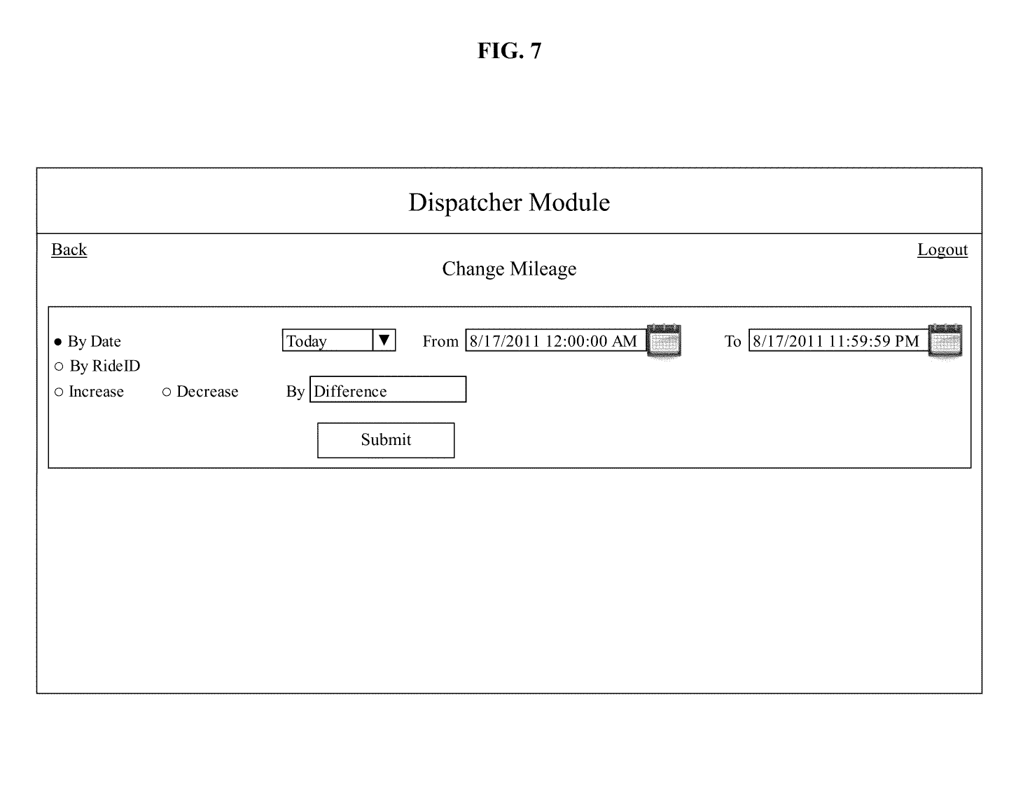

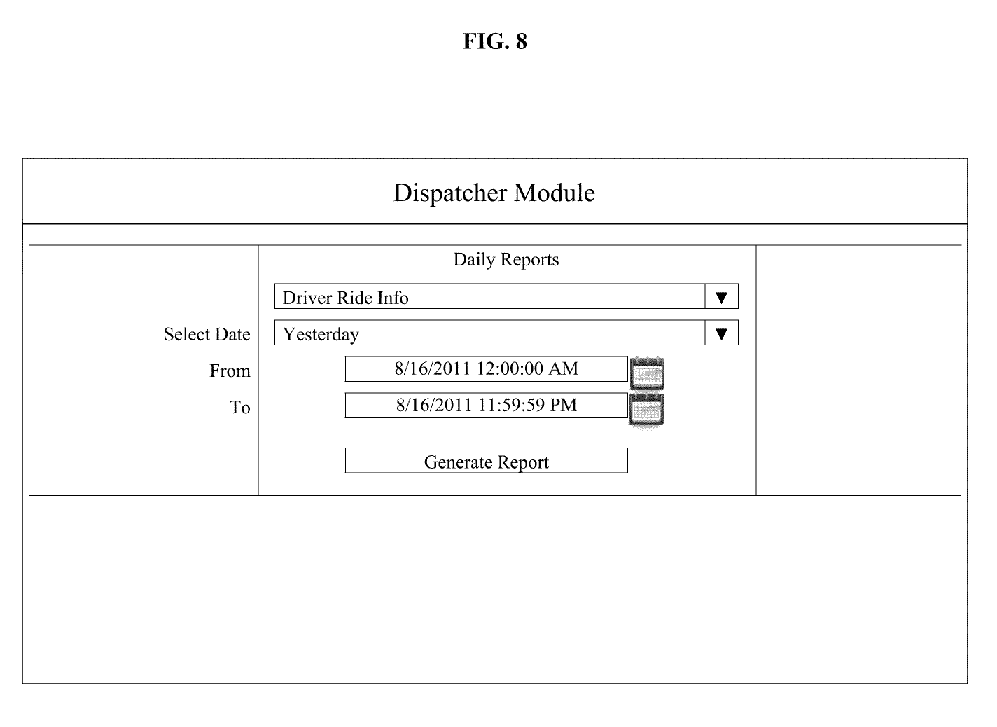

FIG. 7 is an example user interface showing a dispatcher module form used to change the mileage for rides, which can be done either for all the rides between two dates (in bulk) or for a single ride. FIG. 8 is an example user interface showing a dispatcher module form used to generate different types of reports. This functionality is available to both admins and dispatchers.

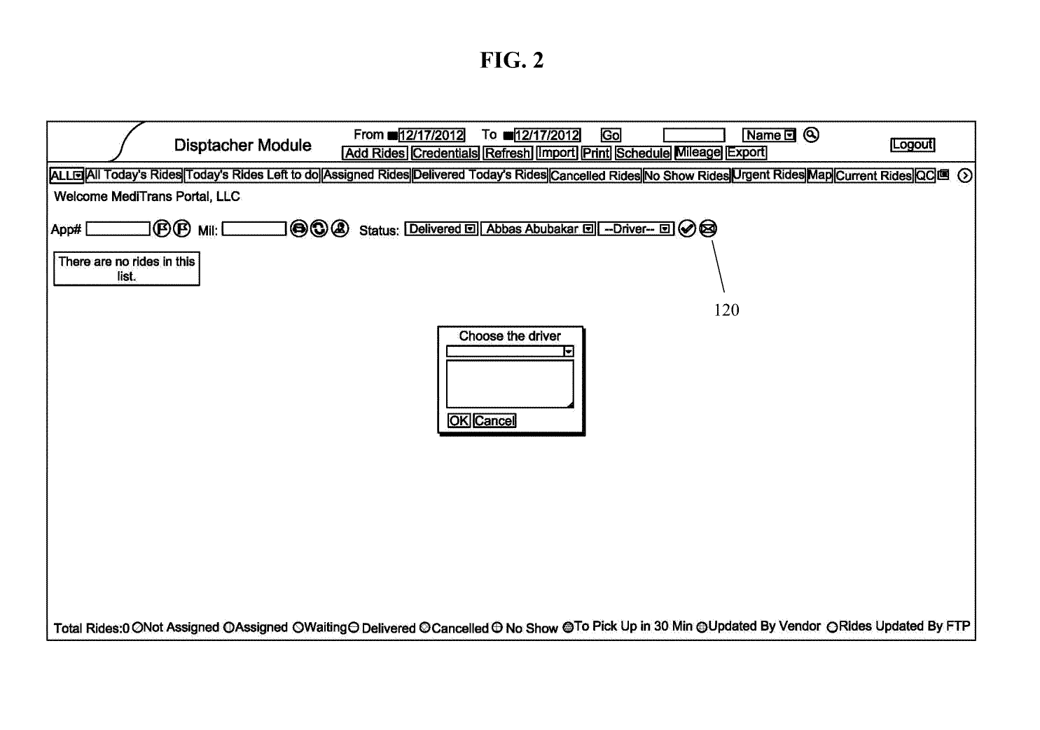

As illustrated in FIG. 2, a dispatcher has the ability to send messages to drivers or contractors from within the system (see 120). The dispatcher can select which driver to send a message to and type the message on screen to send to the selected driver. A dispatcher or other user can send a text message to any cell phone provider in the country; one example of a use of this capability is to send an update to a driver in the field who may be waiting for a ride that has been cancelled.

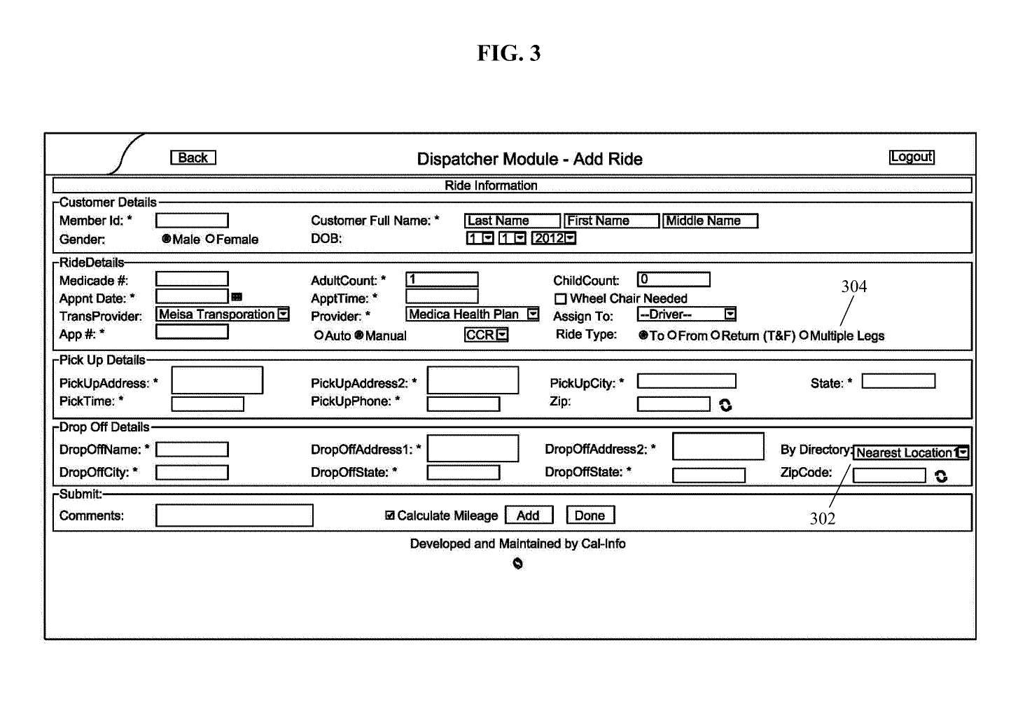

FIG. 3 is an example graphical user interface within the dispatcher module that allows a dispatcher to add a ride. When managing rides, a dispatcher is capable of selecting the nearest location for services from an internal directory 302. This capability assists with avoidance of “long distance hauling.” The dispatcher can also designate “multiple legs” 304 for a ride. For example, a passenger may require a ride to three separate places. Instead of booking three separate rides for the passenger, the dispatcher can combine all three stops into one ride with multiple legs or multiple stops, which saves money and promotes efficiency. A dispatcher can input both common carrier (“CCR”) rides, such as taxi and/or other publicly available transportation methods, and special transportation services (“STS”) rides.

A dispatcher can also edit the ride information. If a dispatcher updates the status for vendor rides and the vendor later updates the ride, the vendor's update is accepted, the status is highlighted in red (or another predetermined color) and the dispatcher's actions are saved and displayed as comments on a mouse over of the status field. The dispatcher can reapply his or her changes if he or she feels they are more appropriate. For example, if a ride was already “delivered” and the vendor then “cancelled” the ride, a dispatcher may reapply his or her changes to indicate the appropriate status of the ride (“delivered” in this example). As an example, rides that have been changed by a dispatcher may appear in magenta to indicate the ride has been changed. This might indicate that there has been an FTP update where the dispatcher has cancelled a ride, preventing anyone from trying to fulfill the ride or submit the ride for reimbursement. Dispatchers also have the option to add new rides.

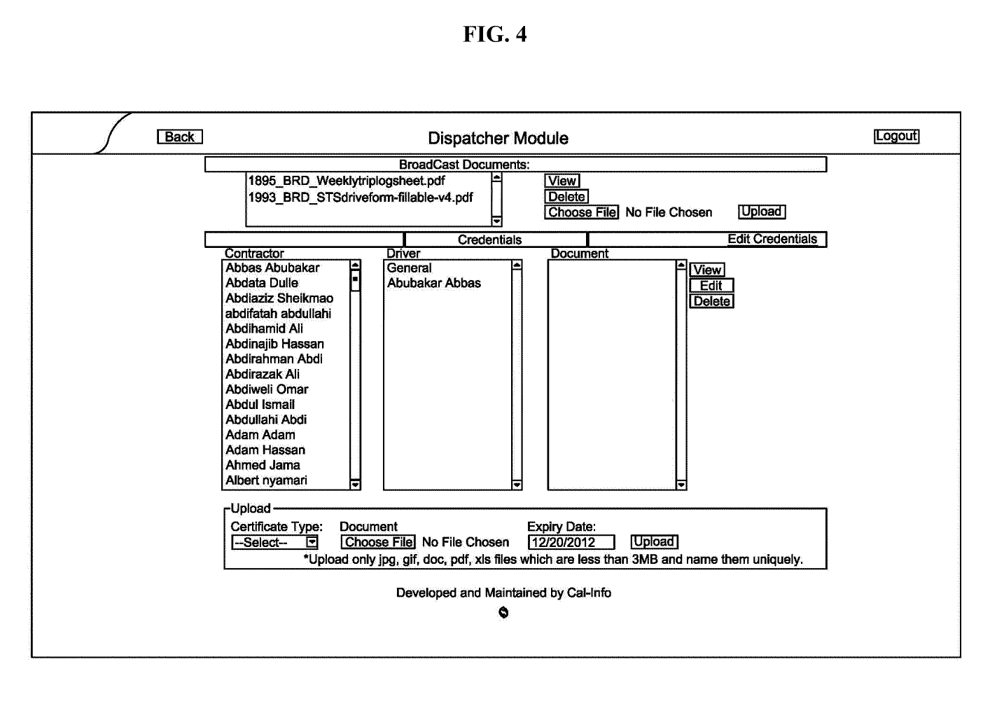

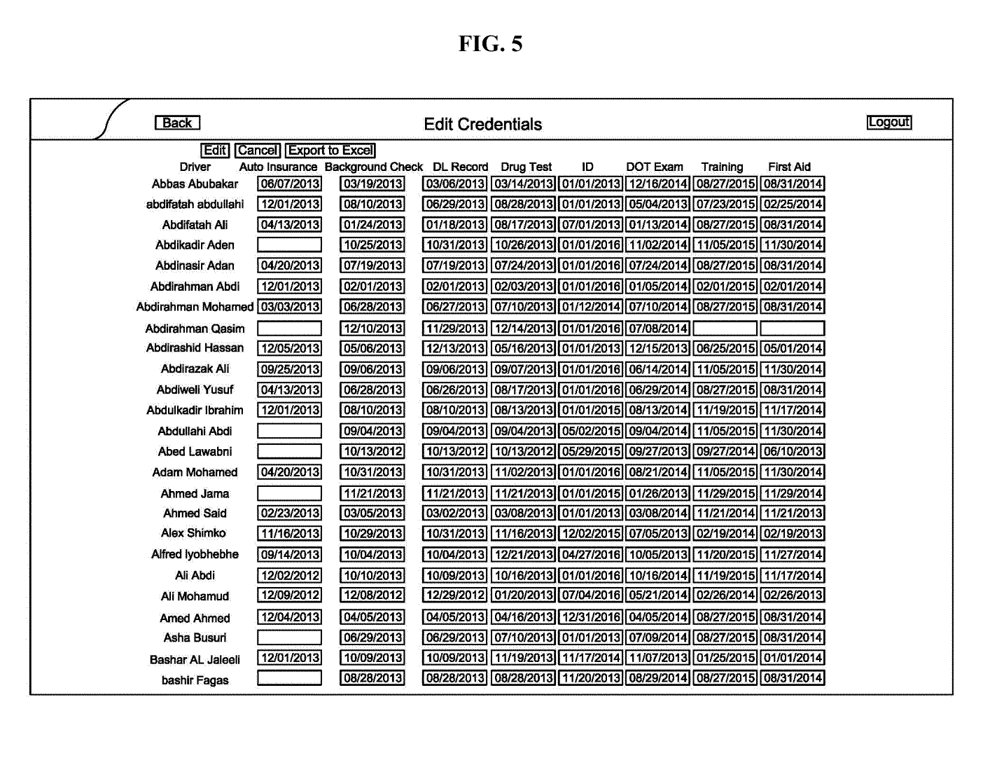

A dispatcher also has admin options, which means a dispatcher can add, edit or delete drivers, contractors, vendors and dispatchers and view the FTP log. Other options for a dispatcher include uploading and viewing driver credentials and importing the HMO/vendor's CSV file, which will be updated in the database. FIG. 4 is an example graphical user interface that illustrates the ability of a dispatcher (or admin) to upload and view credentials for all drivers and cars. FIG. 5 is an example graphical user interface that illustrates an example credentials spreadsheet. The system will send an alert to the dispatcher (or the admin) if credentials are nearing expiration, and will also alert a user of necessary renewals.

Dispatchers can generate the following reports among many others:

1. Driver Ride Info—Shows total mileage, number of rides and no-shows done by each driver for a specified time period.

2. Daily Ride Info—Lists all the ride information for a specified time period.

3. No Show Report—Lists all the no-show rides done along with comments.

4. Billing Report—Gives cost for each ride and the total cost by giving the no-show rate, pick up rate and the rate for the rides for different mileage ranges. This report can be exported to a Microsoft Excel spreadsheet.

5. Vendor/HMO Reconciliation—This allows a dispatcher to upload the vendor or HMO reconciliation file weekly and calculates the total cost by taking values from the database. This report can download as a Microsoft Excel spreadsheet.

These are only a few examples of reports that can be generated using the disclosed system. The system and users of the system have the capability to generate numerous other types of reports. In some embodiments, the dispatcher module may appear as a split screen, allowing the dispatcher to view report results while still viewing the dispatcher module screen.

Dispatchers can also do the following: print the rides for the day; generate the schedule numbers for the rides for a particular date; change the mileage for a ride or a number of rides by increasing the mileage by one or decreasing the mileage by one; search for a ride by using app number, contractor/driver name, or customer name, or by using the pick-up address; navigate to list of rides for any date by using the calendar; sort the rides listed by schedule number, pick-up time, driver/contractor name, mileage, or status; and filter rides by selecting All Today's Rides, Rides Left to do, Assigned Rides, Delivered Rides, No Show Rides, Cancelled Rides, or rides from a specified vendor. Further, a dispatcher (or any other user of the system) can utilize internal search capabilities within the system. The system is searchable within data records based on specified headings and searchable fields.

### 2. Vendor (HMO)

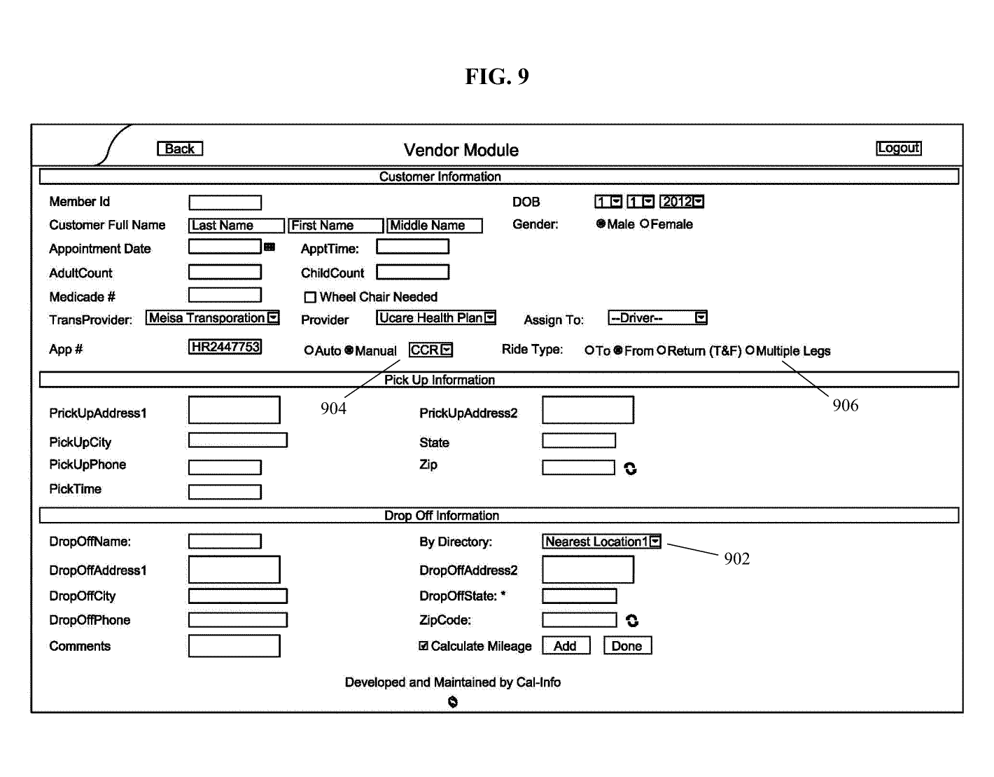

Vendors supply rides either by updating their FTP site or through the vendor module using the “add ride” option. FIG. 9 is an example graphical user interface showing one example of a form used by a vendor to add a ride to the system. Similar to the dispatcher add ride functionality, a vendor can select the nearest location for services from an internal directory 902, designate a ride as CCR or STS 904, and designate multiple legs for a ride 906, among other things.

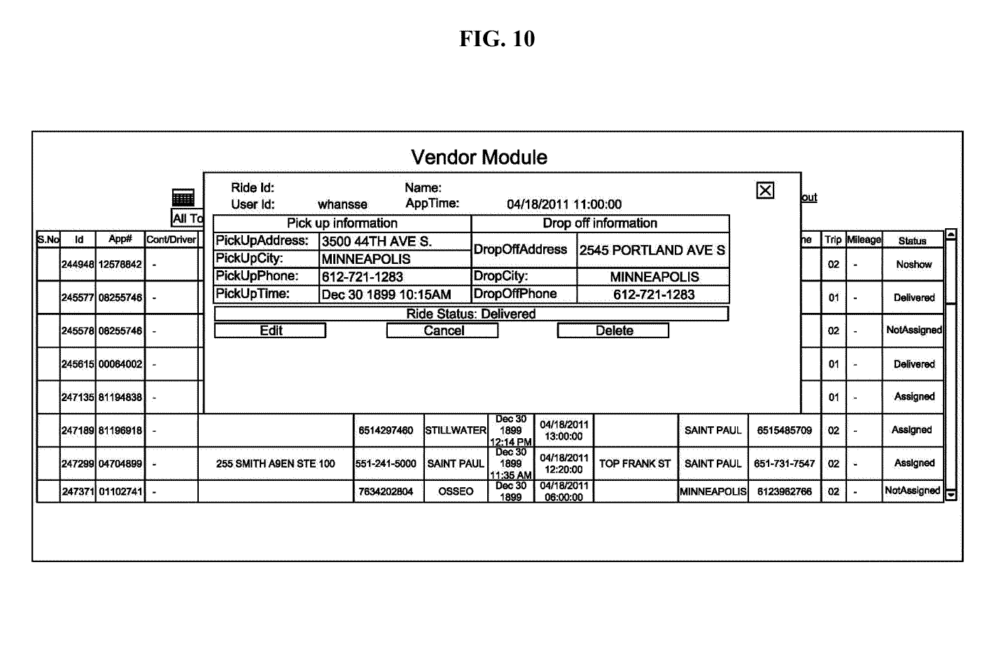

Vendors can see the credentials uploaded for each driver and can also change the information for rides they have sent in. FIG. 10 is an example graphical user interface showing one example of the vendor edit role, whereby a vendor can select any ride sent by the vendor and edit the ride information or change the status of the ride. Vendors also have the option to search and filter rides in a way similar to the dispatcher.

Examples of other functions and/or reports available to vendors include, but are not limited to: viewing all of a specific day's rides sent by the vendor; viewing all rides for a selected date that are not classified as delivered, cancelled or no-show; viewing all rides for a specific day that are classified as assigned; viewing all rides for a specific day that are classified as delivered; viewing all rides for a specific day that are classified as cancelled; and viewing all rides for a specific day that are classified as no-shows. Vendors can only view the rides they have sent in, and cannot view or access rides sent in by other vendors.

### 3. Driver

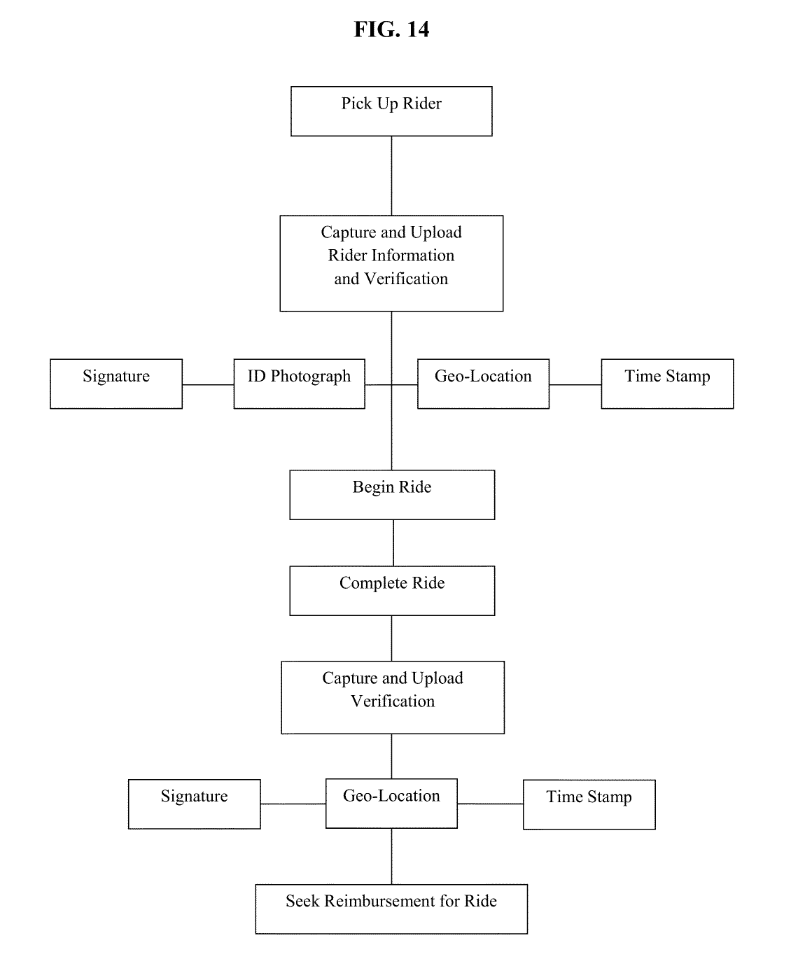

Drivers can see the rides assigned to them and update the status of their assigned rides once each ride is completed. Drivers can upload and view only their own personal credentials. FIG. 14 is a flowchart illustrating one example of the process of a ride from the driver's perspective, before, during and after a ride.

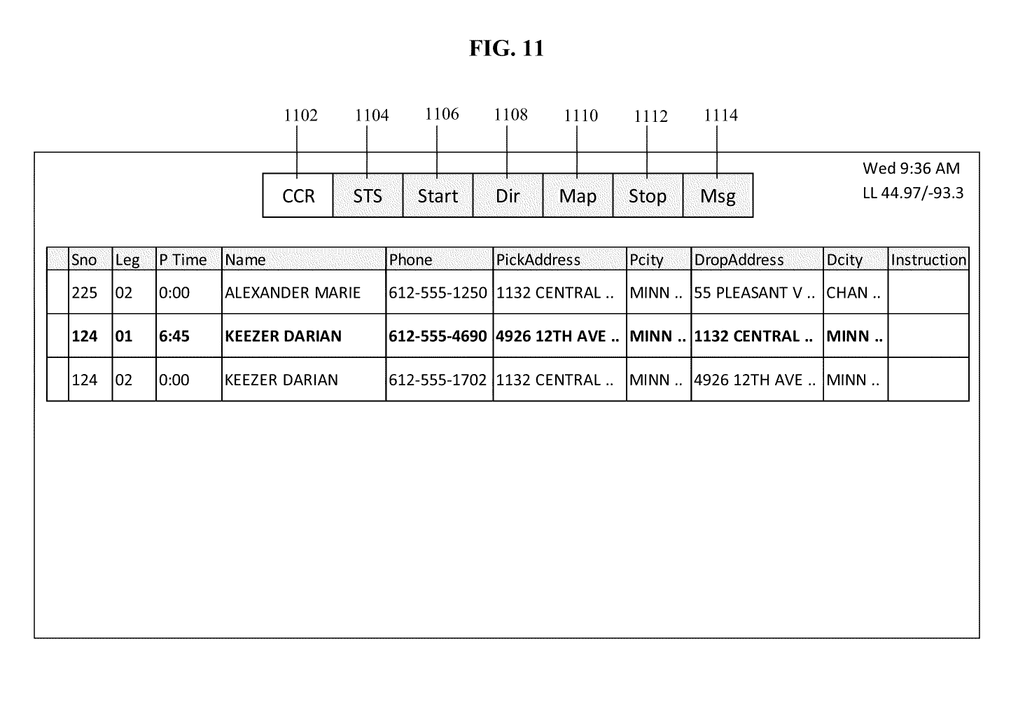

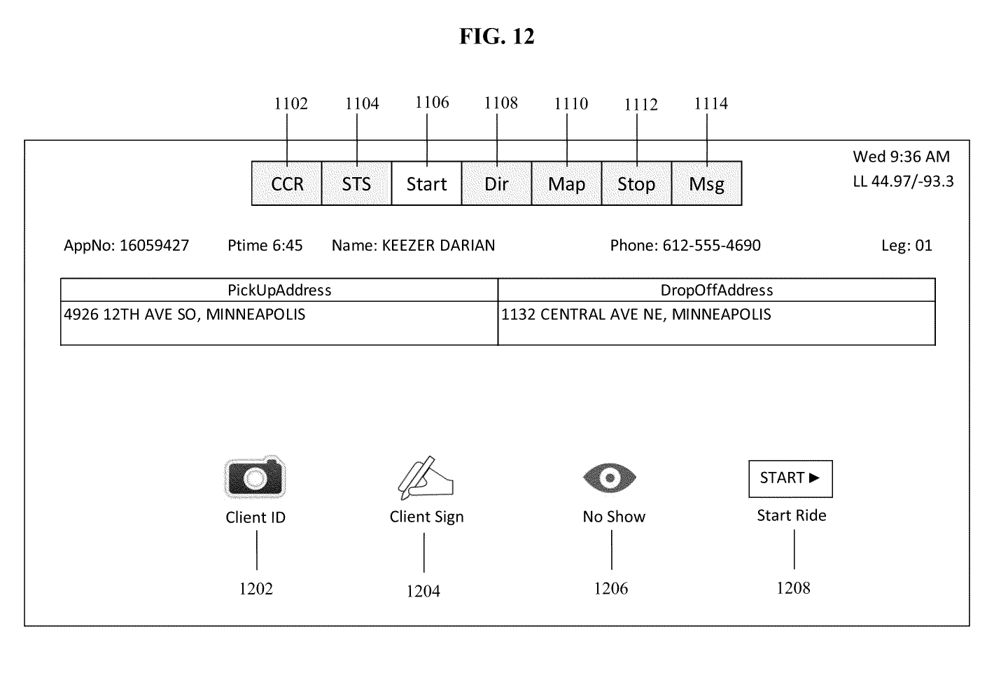

In some embodiments, a driver may use their tablet, smart phone or other mobile device as described above to access the driver module and obtain updates while in the field. Drivers may also use their mobile device while in the field to send data back to the portal, for example, passenger signatures, photos, time-stamps, and start or end geolocations. Uploaded verification information and documents are then later used to determine eligibility for reimbursement for specific rides. FIG. 11 and FIG. 12 show examples of a graphical user interface that may be viewed by a driver from their mobile device. The example interface shown in FIG. 11 illustrates the CCR, or common carrier ride, functionality of the driver mobile application, wherein a driver can view their list of rides for a specific day by selecting the CCR button 1102. The same functionality is available for STS (special transportation) rides by selecting the STS button 1104.

Some rides are classified as STS-eligible. For all STS rides, the system requires drivers to capture four items from the passenger to be eligible for reimbursement. These items are client signature, client photo ID, client signature, and client certificate of need. In some embodiments, the driver will capture these items using the camera on their field mobile device and import or upload them into the portal. In some embodiments, if the driver fails to upload all four of the referenced verification items, the system will not allow the driver to upload the related ride for reimbursement.

The example interface shown in FIG. 12 illustrates the ability of a driver to capture required information when picking up a rider. In this example, this page is accessed by selecting the “Start” button 1106. The driver can capture information such as client ID or photograph (1202) and client signature (1204). The driver can also record no-show information (1206) in the event that the rider does not show up for the scheduled ride. Once required information is captured, the driver selects the start ride button 1208 to begin tracking the ride.

Other functions available to a driver from the mobile application may include viewing built-in directions 1108, following a built-in map 1110, and capturing information when dropping off a rider 1112. As an example, when a ride is completed, the driver may select “Stop” 1112 to capture a client signature and stop tracking information about the ride. Drivers may have access through the mobile application to a messaging system 1114, through which drivers can communicate with their dispatcher or office. The functions of the driver mobile application are available in relation to all “legs” of a ride, as described herein.

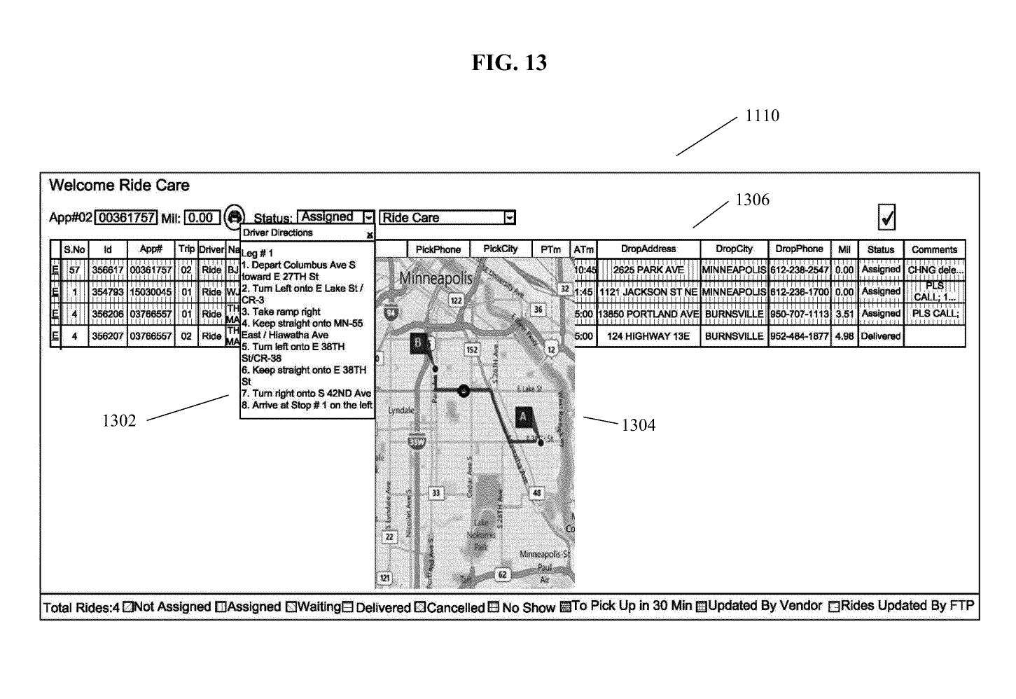

FIG. 13 is an example graphical user interface shown to a driver who has selected to follow a built-in map 1110. The driver mobile application of the presently disclosed system can be accessed by a driver while in transport, and may show driver directions 1302, a ride route map 1304, and/or a list of rides assigned to the driver 1306, among other things.

Drivers have the ability to view, edit and upload their credential information within the system. Each driver can only see their own credential information and do not have access to credential information related to other drivers. A driver can upload, for example, credential certificates; other examples of credentials could include insurance information, liability coverage and limits, certifications, etc., among many other options.

### 4. Contractor

Contractors are a group of drivers. Rides are assigned to contractors by a dispatcher. They can reject rides by changing the status of a particular ride to “Not Assigned.” If a contractor rejects a ride, it is sent back to the dispatcher to be reassigned. Once a ride is assigned to a contractor, the contractor can reassign those rides to one of their own drivers. They can also change the status to “delivered,” “no show” or “cancelled.”

In some embodiments, the contractor module may include the option to view a list of all of a day's rides assigned to the contractor or driver. The contractor does not have the option to edit a ride or its information, but can view their assigned rides and either accept or reject rides.

### 5. Administrator (Admin)

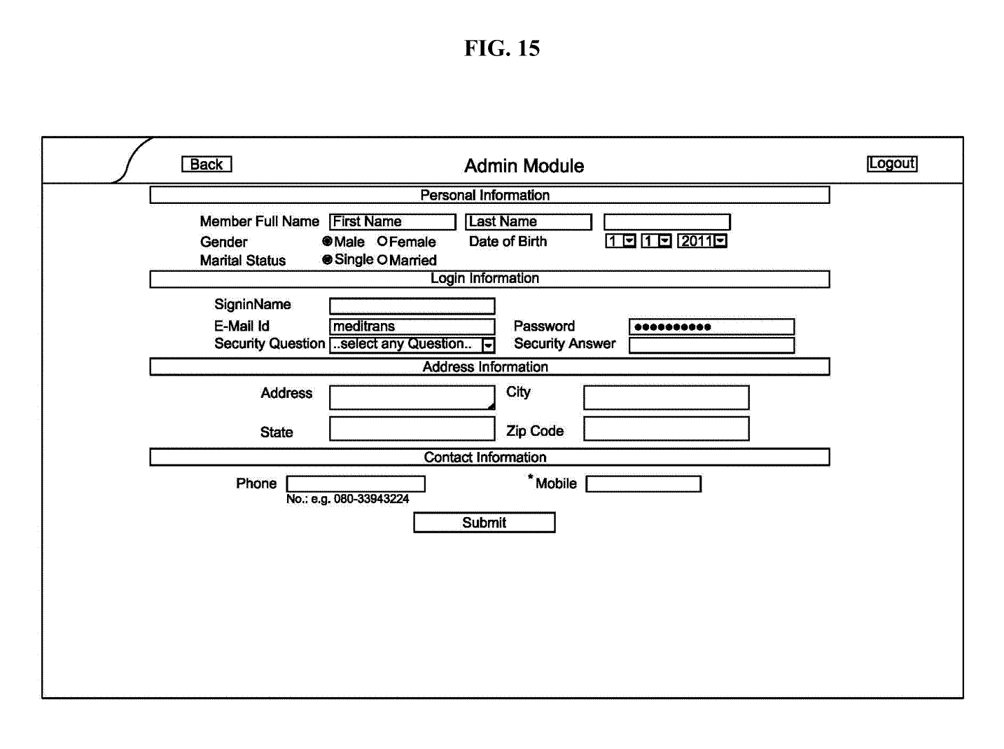

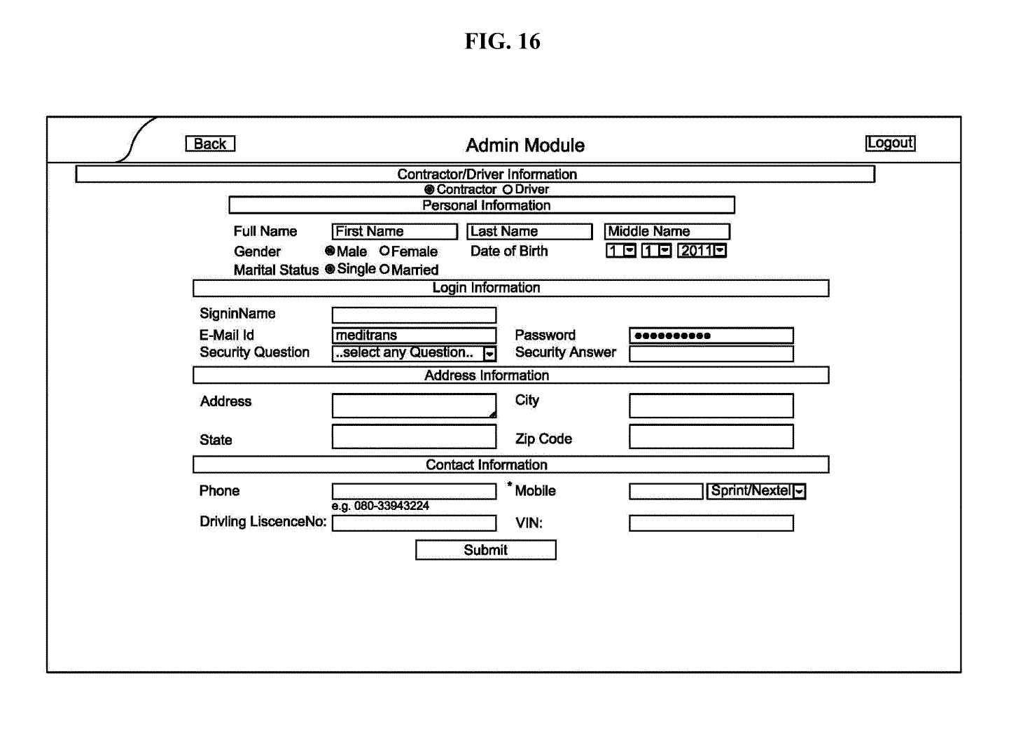

An admin can add, delete or edit drivers, vendors, contractors or dispatchers. FIG. 15 is an example graphical user interface illustrating the ability of an admin to add a vendor to the disclosed system. FIG. 16 is an example graphical user interface illustrating the ability of an admin to add a contractor or driver to the disclosed system. In some embodiments, either of these forms might include adding personal information, login information, address information and contact information. An admin can also import the vendor's CSV files to insert into the system database.

An admin can also change the mileage for a ride or a number of rides by increasing or decreasing the mileage. In some embodiments, the admin module may include a list of payers' prices per ride or per mileage to facilitate billing calculations. As with the dispatcher functionality, an admin is able to view and edit credentials for driver, and may be alerted by the system of upcoming credential expirations. Other functions available to admins include modifying information related to a driver, vendor, contractor or dispatcher; using the messaging or broadcast system; and viewing a map of current driver locations.

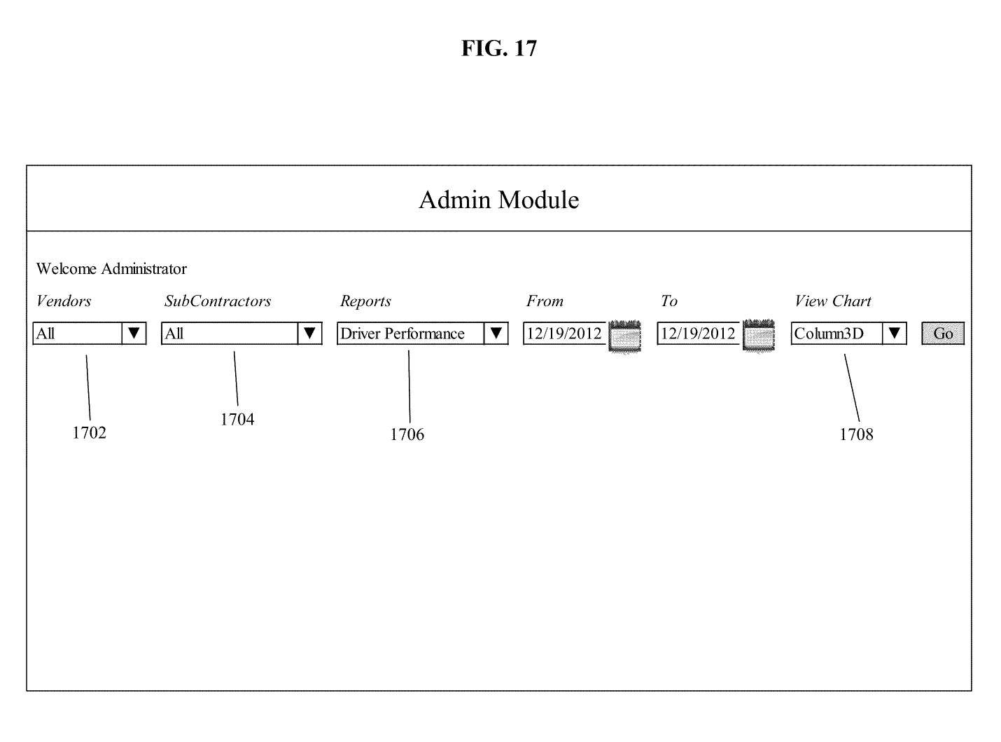

Admins and other users have auditing capabilities as described below. The admin report function, an example of which is illustrated in the graphical user interface of FIG. 17, can be used as an auditing tool in some embodiments. In the example of FIG. 17, an admin can choose to run reports according to vendors 1702 and/or subcontractors 1704. Many report types 1706 are available, for example, driver performance, ride count audit, mileage count audit, multiple ride—same time, contractor ride count audit, call center audit, mobile audit, compliance audit, and passenger audit, among others. Reports can be sorted or filtered, for example, by driver or by date. The admin can also choose how they would like to view the resulting chart (1708), for example, 3D column chart, line chart, bar chart, among other options.

### Method of Operation

### General

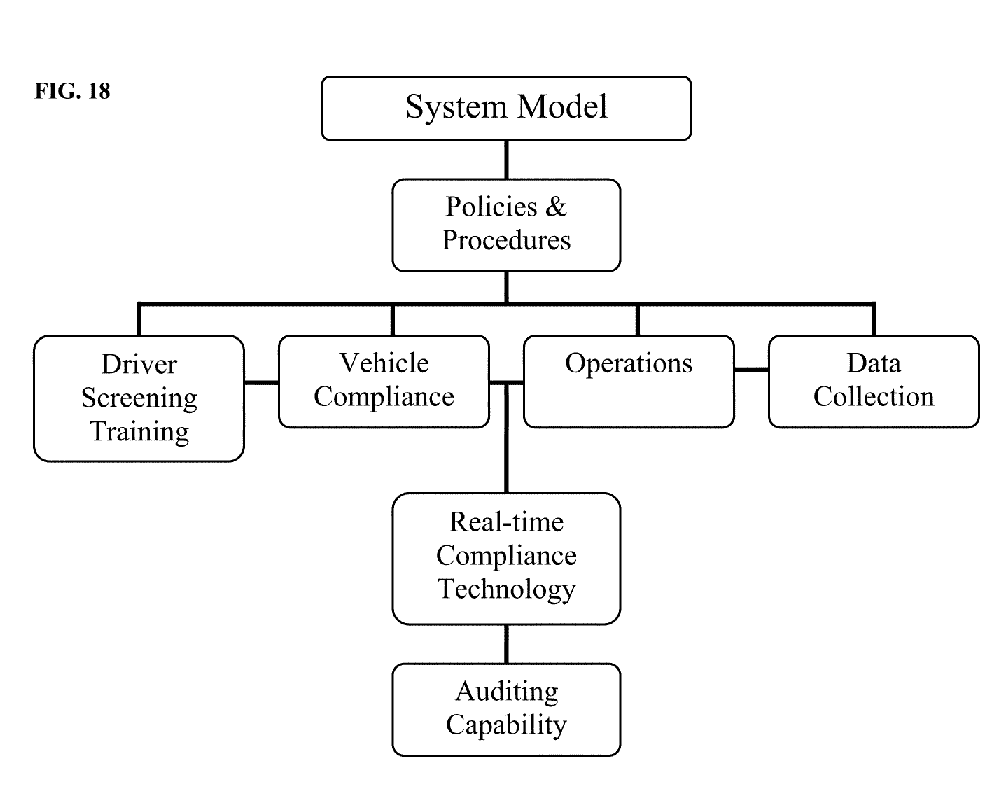

The flow chart of FIG. 18 illustrates, in general, the model of the disclosed system. Policies and procedures related to driver screening and training, vehicle compliance, operations, and data collection are implemented and used together with real-time compliance technology to provide auditing capability to users of the system.

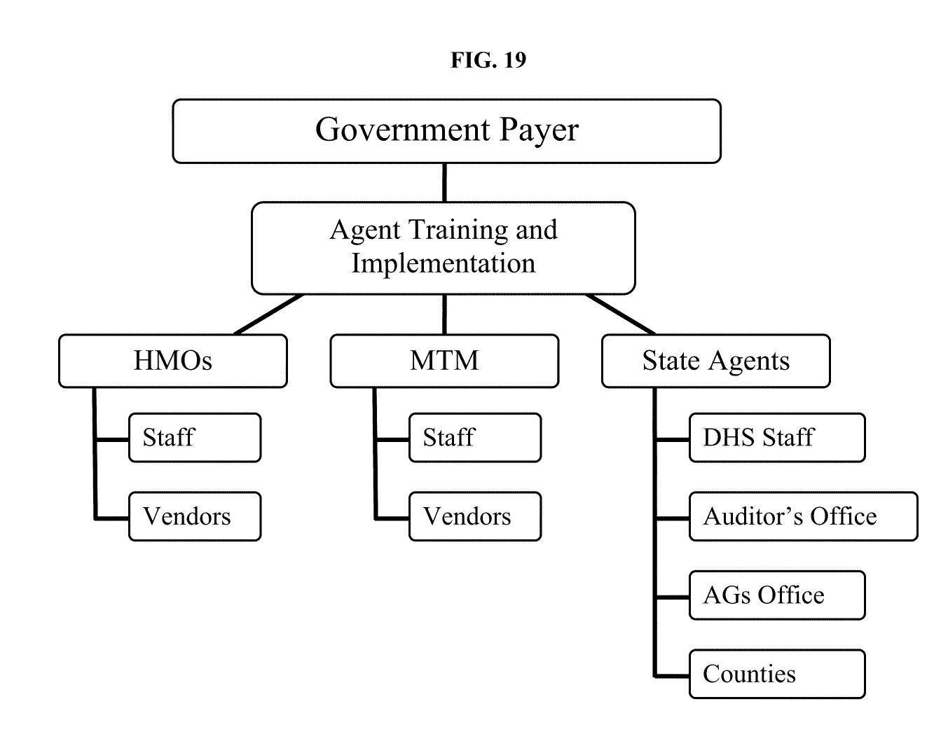

One possible training and implementation process for the presently disclosed system is illustrated in FIG. 19. A government payer may implement a process through HMOs, MTM, State Agents, or others, to train vendors and staff and implement a compliance system such as the system disclosed herein.

Health care providers (HCPs) can sign up as administrators. Health care providers are also considered vendors in some embodiments of the system. A government payer approves the sign-up and assigns the HCP's account to a ride monitoring cell audit. The HCP administrator then will create accounts for his own call center, dispatchers, subcontractors and ride exchange port. Rides are populated daily and appear for assignment to dispatchers. Rides are validated by an auditor, and then assigned to a subcontractor's drivers.

In some embodiments, the software is designed for use on tablets, smart phones or other mobile devices using an operating system such as Android, Windows Mobile, iOS, or others. Rides appear on subcontractor's driver tablets with geocoded locations, driving instructions and live maps. Drivers can record items such as passenger signature, photo, start and end geolocation and time-stamp. There is a “button mode” to record and send an image (photo or signature) with GPS coordinates and a time-stamp to the portal when a ride starts or ends. There is also a “stream mode” to record and send GPS coordinates and time-stamp to the portal at specified intervals (e.g. every one minute). Admins can run a mobile app report which shows where the driver picks up a rider, then determines the route for a specific trip and calculates what the mileage should have been for that specific trip. The application then compares the proper calculated mileage to the driver's actual trip mileage. In one embodiment, if there is a variance, the system will only allow a driver to charge for the proper mileage as determined by the app. This allows an admin to limit billing to what the mileage should have been if it had been properly recorded.

Ride workflow is managed in the following manner. As illustrated in FIG. 21, portal stakeholders are connected via a network. All contractors, drivers, vehicles and credentials are populated in exchange. Rides enter the system via secure delivery from call center. All rides are visible to the ride exchange. Rides are dynamically assigned to various contractors/drivers. Drivers can view their assignments online on their mobile device instantly. Drivers get pre-calculated mileage, driving directions and map for each ride. Upon initiating a ride and completing it, tablet timestamps the journey. Stakeholders can view in real time the current position of each vehicle. Rides may be delivered, cancelled, re-assigned or marked as waiting or no-show. The portal manages vehicles, drivers, rides, billing and reporting.

Audit tools are included in the disclosed system and technology. The system is capable of generating various types of audit reports (for example, through the admin module) which retrospectively show a report of specific events that have occurred. Some report options include, but are not limited to, driver ride information, daily ride information, no show reports, billing reports, vendor reconciliation, and vendor sub invoice, all of which are described in more detail above. There are numerous other types of reports that can be generated within the disclosed system. The audit module performs data analysis and reports possible discrepancies. Heuristic algorithms are present to detect suspicious activity and patterns. Extensive reports and charts give accurate statistics on performance. Rides are monitored in real-time. Driver credentials are verified online and any out-of-date or expired credentials will be blocked; the system will not allow a driver with expired credentials to submit rides for reimbursement. Credentials can be viewed as shown in FIG. 5 or in other forms. Passenger acknowledgement is captured online. Over a period of time, data mining may be performed to catch anomalies. Subcontractor performance and ratings can be submitted and viewed for auditing.

Salient features of the disclosed software and technology include the following:

State of the art portal integrating GPS and mobile devices

HIPAA Compliant SSL and 128 bit RSA encrypted transfers over the internet

Real-time updates of ride status

MAP based navigation

Accurate mileage recording

Full accountability of rides

Automated billing and accounts

Scalable architecture

Cloud-based, which lowers hardware investments

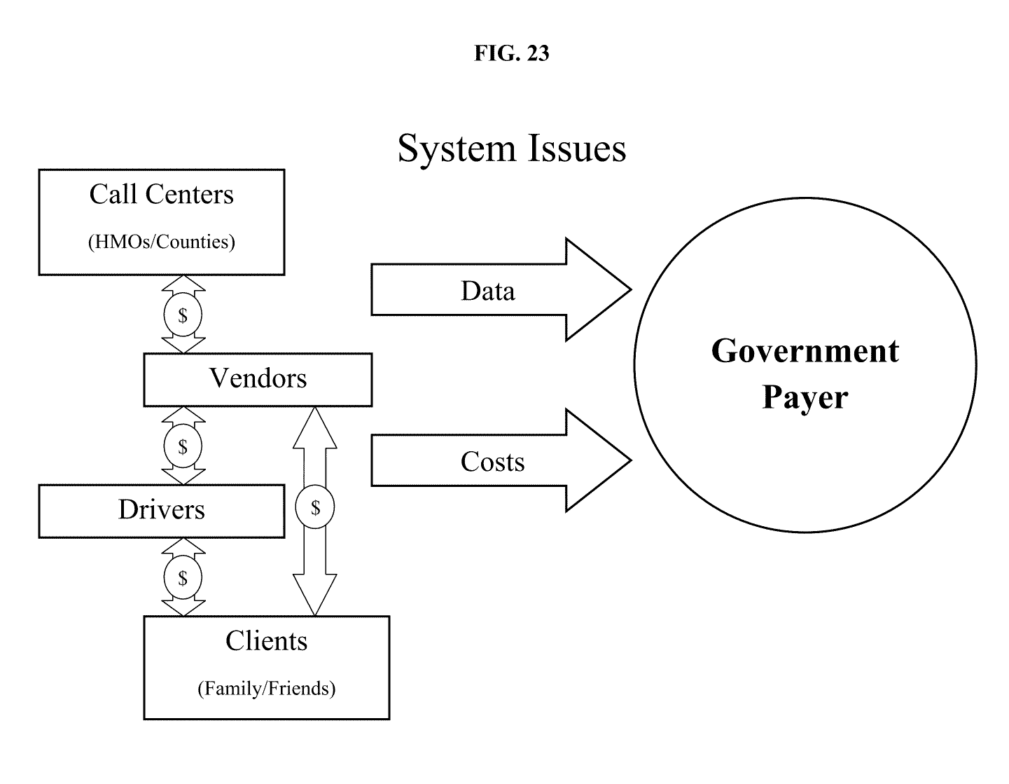

In general, the system helps to resolve issues in the non-emergency transportation field, such as those illustrated in FIG. 23. Compliance and fraud issues with call centers, vendors, drivers or clients can result in fraudulent data and ultimately result in additional costs to the government payer. The disclosed system works to resolve these compliance and fraud issues.

### EXAMPLES OF USAGE

The following examples show how the disclosed non-emergency transportation compliance and auditing software and technology may be used in specific situations to prevent fraud and promote regulatory compliance. These examples are not intended to limit the ways the disclosed software and technology may be used.

### Example 1

Problem:

Inappropriate relationships exist among broker or HMO call center employees. The most profitable legitimate rides or planned fraudulent rides can easily be assigned to favored drivers, who may share cash benefits with assigning employee and/or the client. The broker or HMO is not able to easily audit and prevent fraudulent practices, particularly in certain cultural communities.

Solution:

The disclosed billing software and audit process detect such relationships. Each call center ride-assigning representative is issued an Employee ID Number that will be part of the ride information or data electronically stored in the disclosed electronic ride data exchange system. A report is generated reflecting the activities of all call center representatives and their allocations of rides to different vendors/drivers. A graph will illustrate the number of rides allocated, type of rides, number of miles per ride, and the final destination of such rides.

### Example 2

Problem:

The current Driver pay structure is based on pick-up and drop-off fees as well as mileage reimbursement. The current pay structure system creates an incentive for reporting fraudulent mileage, thereby inflating the cost to the provider and/or the government.

Solution:

The disclosed software and technology includes a built-in mileage modular as well as GPS technology accounts for every ride and calculates the mileage within the software, not allowing drivers to manipulate the reported mileage. Accurate mileage is assured for every ride using the disclosed system.

### Example 3

Problem:

“Ghost Rides” or “Inappropriate Destination Rides”

“Ghost Rides” refers to billing of medical appointment rides that never took place. This may occur when a client schedules a ride, but never goes there and then receives money from the driver in exchange for a trip signature. This may also occur if a medical appointment does take place, but a client gets an alternate ride home and gives the driver a signature in return for consideration to driver. Driver bills for return rides that never took place, with an agreement between driver and client to obtain a signature from the client in exchange of a consideration.

“Inappropriate Destination Rides” occur when a client schedules rides to destination appropriate for the non-emergency transportation service, but instead driver takes them to a casino, liquor store or other destination not approved for eligibility.

Solution:

The disclosed technology accounts for every ride from time of pick-up up until return rides. The disclosed software combines with GPS technology to generate multiple reports on the history of the ride from time-stamped pick-up and drop-off locations, route taken, and speeds attained, with the route plotted on a computer screen. The system is fully auditable in real time or with remote access viewing by transportation provider, HMO, vendor, broker or any authorized state agency.

### Example 4

Problem:

“Arming,” or group-scheduling of rides. This occurs when drivers schedule appointment rides in groups, yielding higher driver/provider profit per ride.

Solution:

The disclosed software and technology will detect such repeat practices and reject any billing for drivers who are arming people and billing inappropriately. Rides will be stamped in real time, and a report will be generated to reflect the driver performance that will detail the arming if it exists.

### Example 5

Problem:

Drivers who are not properly credentialed and vehicles that are not properly certified. In the case of a serious accident harming an eligible client, the client's attorney will look to the qualifications of the driver and the certification and inspection history of the vehicle. The state may ultimately be liable in certain circumstances.

Solution:

The disclosed system provides record management for instant, online monitoring of driver and vehicle eligibility, with alert mechanisms for deficiencies and non-compliance in each category.

### Example 6

Problem:

Eligible client impersonation by non-qualified person seeking transportation services, sometimes in collusion with an eligible person allowing their identity to be used by a friend or by swapping identity cards.

Solution:

The disclosed technology is capable of scanning the client's signature, or biometric verification. A report will be generated to match the signature of the real client and find any discrepancies.

### Example 7

Problem:

Abusive over-use by eligible clients of transportation benefits provided by the government or by HMOs/vendors.

Solution:

The disclosed software and technology will generate a monthly report for each client and chart their medical and social transportation usage, watch for any trends and cross reference multiple appointments on the same day as well as exaggerated numbers of appointments monthly.

### Example 8

Problem:

Some clients are self-selecting trips to medical providers or drug stores that are very distant from their home. Where STS-eligible rides are managed by the client directly, there is no mechanism to direct clients to the most efficient service provider, such as the nearest medical provider or drug store.

Solution:

The disclosed software shows the nature of each ride, trends, and mileage, and compares these factors to the best possible outcome, finding all of the nearest medical provider or pharmacy that has the same service instead of traveling many miles for same service. The nearest service provider can be selected by the dispatcher.

### Example 9

Problem:

Some Interpreters have been contributors to the medical transportation fraud and abuse practices. All interpreters have a list of “their own” clients. Fraudulently scheduled medical transport/interpreter appointments offer great opportunities for fraud and abuse. Interpreters can arrange medical transportation trips and drive clients to the appointment with their own car, thus earning the Interpreting fee. They can also make arrangements with transport providers based on referral fees.

Solution:

The disclosed technology utilizes an application on driver smart phones or tablets that are interfaced with the disclosed software and manage the status of each ride in the field in real time. A report will be generated for each driver's smart phone or tablet with a summary of all rides that took place.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A method of managing non-emergency medical transportation in a computing system comprising at least one server to host the transportation management system and at least one computing device communicably coupled to the at least one server through a communication network, the method comprising:
assigning a driver a unique account identifier;
transmitting the location of the driver to a central server;
validating the credentials of the driver;
assigning the driver to a patient transport job with a pick-up location and a drop-off location;
picking up a rider by the driver;
capturing unique identifiers of the rider, including at least a photograph and a signature;
validating pick-up of the rider by reference to geo-location and time-stamp transmitted by the driver to the central server;
monitoring the location of the driver and the length of time between the pick-up and drop-off location; and
validating drop-off of the rider by reference to geo-location, time-stamp and signature by a person associated with the drop-off location and transmitted by the driver to the central server.

2. The method of claim 1, wherein at least one computing device is one of a mobile device and a computer communicably coupled with the at least one server for data communication.

3. The method of claim 1, wherein the communication network utilizes 128 bit RSA encrypted transfers over the communication network.

4. The method of claim 1, further comprising recording and storing the time-stamp and geo-location data for records and billing purposes.

5. The method of claim 1, further comprising recording and storing the location of driver information.

6. The method of claim 5, wherein the computing device calculates mileage information from the location of driver data as well as patient pick-up and drop-off data.
